(19) United States
(12) Patent Application Publication
(10) Pub. No.: US 2002/0150462 A1
(43) Pub. Date: Oct. 17, 2002

(54) Device for stacking folding-box tubes

(76) Inventor: Stefan Furthmuller, Welzheim-Breitenfurst (DE)

Correspondence Address: EMCH, SCHAFFER, SCHAUB & PORCELLO CO, P O BOX 916, ONE SEAGATE SUITE 1980, TOLEDO, OH, 43697

(21) Appl. No.: 10/124,640

(22) Filed: Apr. 17, 2002

(30) Foreign Application Priority Data
Apr. 17, 2001 (DE) DE 101 18 813.7

(51) Int. Cl. B65G 57/03

(52) U.S. Cl. 414/790.6; 414/790; 414/794.8; 414/907

(57) ABSTRACT

A device for stacking folding-box tubes demonstrates a vertically-adjustable elevating platform. First temporary bearing means, which can be pulled out of or advanced into the stacking well, are located above the elevating platform. Another set of temporary bearing means can be pulled out of the stacking well as well as moved downward within the stacking well. The second bearing means also press a completed stack together in order to be able to thread it between a conveying device of a holding-down appliance. The first temporary bearing means provide for uninterrupted stacking within the stacking well while the elevating platform, together with the second bearing device, are busy carrying the stack away.

A device for generating small stacks from a stream of incoming folding-box tubes is known from DE69500305. The products arrive at fixed time intervals. The distance between successive products defines the maximum interval within which the stacking device must switch to the next stack. The device must work uninterruptedly at very high speed to be in a state in which it can receive the products without causing repercussions on the folding machine preceding it.

The mechanical components of the stacking device must consequently work at very high speed. To keep the speeds within fairly tolerable bounds, two stacks, which the temporary bearing means separate from each other, are formed one on top of the other. This gains the time required to remove a completed stack from the stacking device.

The maximum speed at which the stacks can be moved is based on the frictional pairing between the products lying on top of each other within the stack. If the stack were accelerated and braked too rapidly, the products in the stack would slide against each other. The static friction between the products restricts the maximum acceleration and consequently also the attainable speed. The intermediate stacking or temporary arrangement of two stacks one on top of the other gains time for removing a completed stack from the machine, namely about as much time as needed to form the next stack.

There nevertheless exists the problem of bringing the temporary bearing means into the stacking well fast enough without hazarding a collision with the products that are arriving at high speed. A rack, which forms the temporary bearing means, is present in the known machine to reduce the probability of collision. The prongs of the rack can penetrate through the slots of the downstream limit stop to form temporary bearing means within the stacking well. The rack must execute a vertical movement within the well. The rack pulls out of the stacking well at the well's lower end and is carried back outside the well to its top position so that it can advance into the stacking well above the inlet where the products shoot into the well. The rack then moves downwards in the stacking well in parallel flow with the products falling down within the well. Since the rack very rapidly passes through the region in which take-down rollers shoot in the products, there is no danger of collision with the incoming products even if the rate of descent is slow.

The known machine demonstrates a type of compound slide rest with two linear axles running perpendicular to each other so that the rack will execute the desired motion. Two continuous straps, which are attached to the supporting beam to which the rack's prongs are fastened, drive this fitting arrangement. A toothed belt, which circulates around stationary rollers, performs the drive. Due to this fitting arrangement, the rack always executes the same motion, regardless whether the products being stacked are short or long, as viewed from the conveying direction.

The belt's three-dimensional curve must be shaped so that the rack's travel, viewed from the conveying direction, is sufficient to pull the rack's prongs back behind the limit stop in question, even for the largest products. For very small products, this results in an extremely large idle stroke, which costs unnecessary time and compels very high speeds even for small products. In particular, the folding machine can therefore not work at a higher speed with small products, although these smaller products would permit such operation without any trouble.

Moreover, it is very technologically expensive to guide the compound slide rest with its two linear axles perpendicular to each other, and the guiding causes large masses to be moved with large forces of the second order of magnitude.

Known machines also use the temporary bearing means in the shape of a rack to hold down the stack of folding-box tubes and to transfer it, pressed down, into an output conveying device.

In this region, it is necessary to guide the rack parallel to the output path and it is consequently not available to accept blanks for a long time interval. To bridge this time, in which both the rack is not available for stacking and the elevating platform can't be used, additional bearing means in the form of fingers are also used. The fingers support the stack of incoming products long enough for the elevating platform to release from the previous stack and ascend upwards to the stacking height.

Proceeding from this, it is the objective of the invention to create a device for stacking flat products, particularly folding-box tubes, which device is flexibly adaptable to size and mechanically less expensive.

The device with the characteristics of claim 1 solves this objective according to invention.

The device according to invention demonstrates two types of temporary bearing means. The first bearing means are fingers or comparable elements that can be moved into or out of stacking well's structure clearance without executing a vertical movement.

They are located not too far underneath the plane in which the conveying device shoots the products into the stacking well. However, they are arranged low enough to receive a stack that has been generated during the time that the elevating platform isn't ready to accept products. In this respect, the height of this stack correlates with the time that is needed to get the platform free and guide it back to the stacking position.

The second temporary bearing means operate as a holding-down device to hold together the completed stack that has been formed on the elevating platform and to thread the stack into the output conveying device. The second temporary bearing means must execute two movements in order to satisfy this task. They must move vertically through the stacking well and they must additionally move out of the well's structure clearance.

In the solution according to invention, the prongs of the second temporary bearing means do not move parallel to the axis of the stacking well, but move along an arc that has a large radius. A swiveling axis, running perpendicular to the conveying direction and horizontal, is provided for this. It manages to accomplish the arc-shaped motion, making another linear axis superfluous. In the solution according to invention, it suffices for the second temporary bearing means to move along one linear axis only during the return motion out of the stacking well and the forward motion into the stacking well. The motion through the stacking well from top to bottom and outside the stacking well from bottom to top is not a straight movement.

The corresponding position of the swiveling axis therefore provides that, in the bottom position, an underside of the second temporary bearing means lies parallel to the elevating platform's stacking surface and that the return motion out of the stacking well will occur parallel to the elevating platform's bearing area.

It turns out that the angle error of the bearing side of the second bearing means has no negative impact on the stack's quality during its pass through the stacking well. For this, the mechanical expense of guiding the second temporary bearing means can be substantially reduced.

The use of independent drives for the swivel, forward, and return motions makes it possible to adjust both kinetic strokes completely independently. This also reduces the idle motion, and thus the dead time, for pulling the prongs back behind the downstream limit stop. The device is thus also in a position to handle folding machines that operate at higher speeds for smaller folding-box tubes.

Particularly good stacking is achieved by designing the one limit stop, preferably the limit stop located upstream, as a vibrator. This also permits the folding-box tubes to be adjusted later, when the seam has been glued and the bonding agent has not yet cooled down completely.

Reliable removal of the completed stack can be accomplished if the output conveying device comprises of a plurality of conveying belts running parallel next to each other. The taking away of the stack from the elevating platform is improved when the platform is likewise shaped fan-like and at least one of the conveying belts extends into a gap between the prongs of the elevating platform.

A low-built elevating platform, which doesn't demonstrate any rollers and doesn't require any translating parts, can thereby be achieved in order to push the stack down from the elevating platform.

Other conveying belts can run laterally next to the elevating platform and extend up to its upstream edge.

The easy movement of the conveying belts and their freedom from maintenance is improved if rollers support the belts in the region of their respective driving strands. This prevents sliding supports.

Clamping the finished stack in a holding-down appliance holds the stack down and provides additional pressing needed on the top folding-box tubes. This appliance is also suitably equipped with continuous conveying belts that operate on the top of the stack. The driving strands of these belts run parallel to the surface formed by the driving strands of the conveying belts and upon which the stacks rest.

As for the rest, further developments of the invention are the subject matter of the dependent claims. In these claims, such combinations for which no explicit example is furnished shall also be viewed as claimed. The drawing presents one example of the subject matter of the invention. It shows:

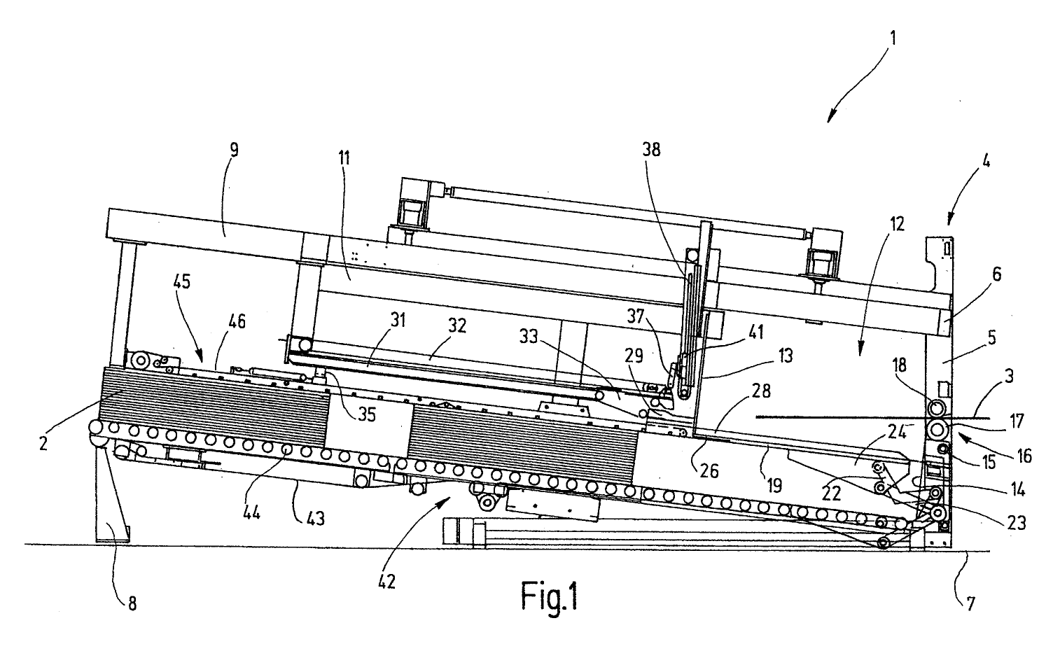

FIG. 1 a device for stacking folding-box tubes in a strongly schematized side view, and

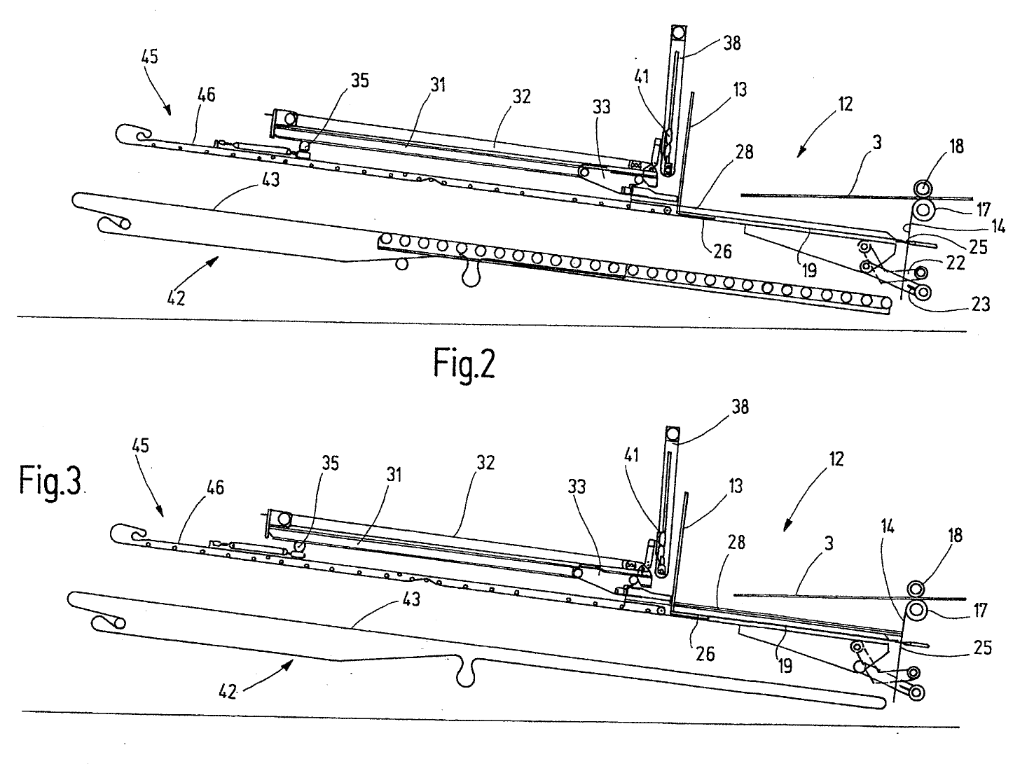

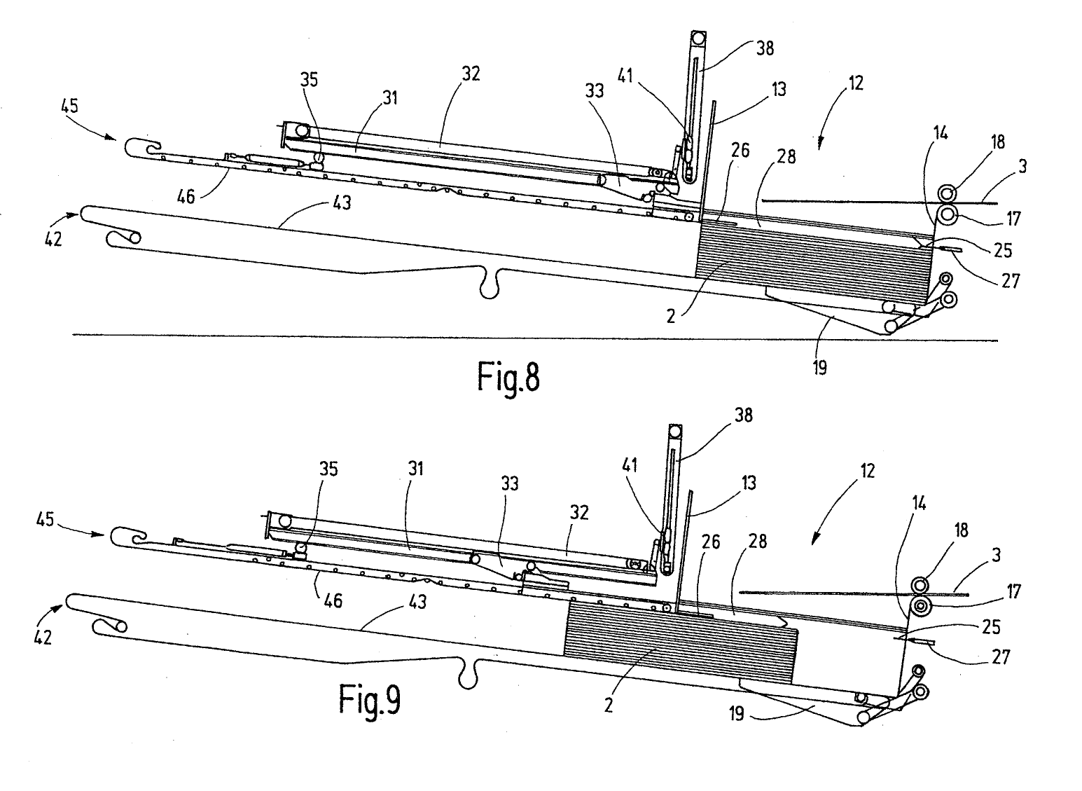

FIGS. 2-10 the device depicted in FIG. 1 further simplified into separate functional steps, and

FIG. 11 the device depicted in FIG. 1 for particularly large folding-box tubes or folding-box tubes with large elastic pull.

FIG. 1 shows a device 1 for making stacks 2 out of flat products 3 such as folding-box blanks or folding-box tubes. The representation is very schematized, only the parts essential for understanding having been illustrated.

In FIG. 1, the products 3 run from right to left and may possibly come from a folding machine in which the folding-box blanks are shaped into folding-box tubes that are glued or tacked along the seam. In FIG. 1, the direction to the right is upstream in terms of the flow of products 3, and a motion running to the left is a motion directed downstream.

A machine frame 4, which is illustrated strongly schematized and shown cut open, belongs to device 1. The machine frame 4 demonstrates lateral columns 5, which are connected together by a transverse yoke 6. The columns 5 stand on a base foundation 7, upon which support columns 8, which are also backward, stand upright. A top machine yoke 9, to which an underframe 11 is fastened, extends between the backward support stands 8 and columns 5.

A stacking well 12, which is open on the side, bounded by a limit stop 13 in the conveying direction (downstream), and bounded upstream by a limit stop 14, is designed within the machine frame 4 downstream from the two columns 5.

The limit stop 14 comprises of a basically flat plate, which demonstrates vertical slots. The plate 14 is fastened to an eccentric shaft 15, which is rotatably mounted between the two columns 5. The limit stop 14 that is located upstream thus serves as a vibrator. The limit stop 13, in contrast, is basically stationary during operation, but its distance to limit stop 14 can be set.

Limit stop 14 and limit stop 13 both define planes that are parallel to each other.

A conveying device 16, comprising of two conveyor rollers 17 and 18, is provided for conveying the products 3 into stacking well 12. The two conveyor rollers 17 and 18 are mounted, horizontally and with parallel axes, between the two columns 5 and are driven by a rotary operating mechanism.

Their circumferential speed is larger than the speed corresponding to the conveying velocity that delivers the products 3 coming from the right.

The products 3 occur in a continuous stream on conveying device 16 and are separated from each other within the stream. They shoot into the stacking well 12 at high velocity between rollers 17 and 18 and fall downwards into the well lying crosswise, as will still be explained in detail below.

An elevating platform 19 which, with the aid of connecting rods 21 and 22, can move back and forth between the two positions that can be seen in FIG. 1, is located in the lower region of stacking well 12. The elevating platform 19 is designed like a rack and demonstrates a plurality of prongs that extend parallel to the conveying direction and which are connected together by means of a reinforcing element 24. The motion of the elevating platform 19 is essentially parallel to the surfaces that are formed by the limit stops 13 and 14. Limit stop 13 is similarly designed as a rack and comprises of a plurality of prongs that basically hang vertically downwards. Slots that run vertically and are open at the bottom are contained between the prongs.

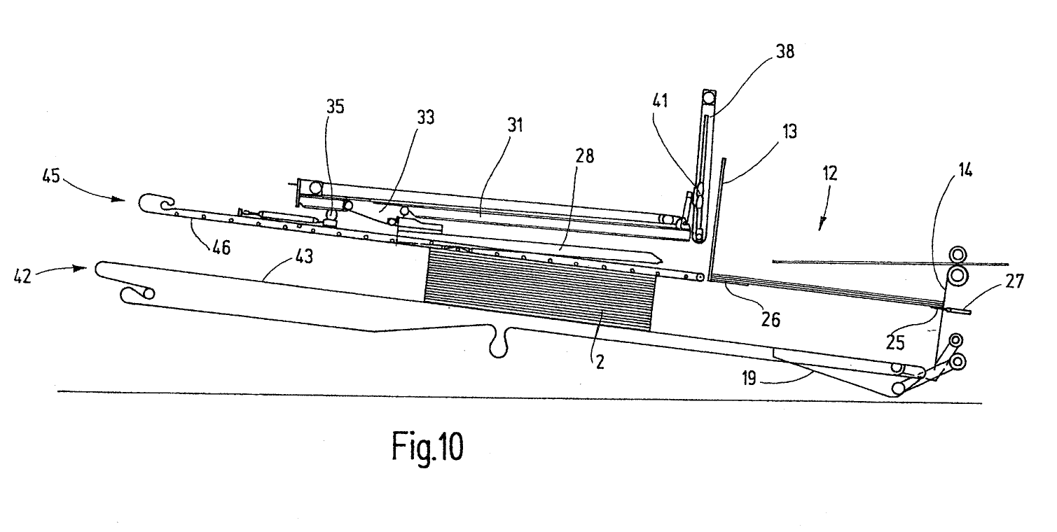

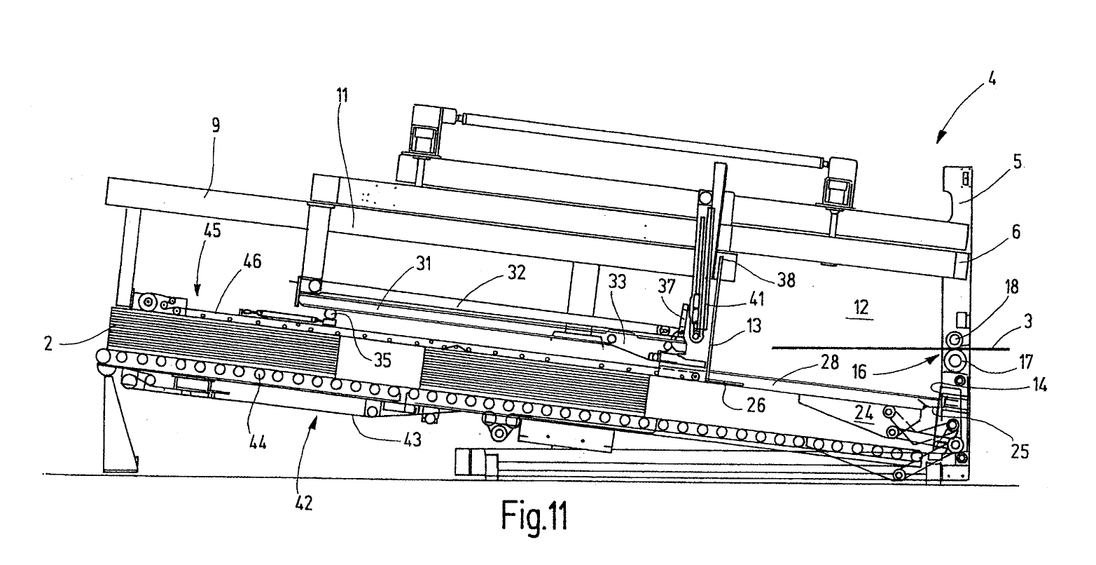

First temporary bearing means 25 and 26, which can best be seen in FIG. 10, are provided in the region of the top stop position of elevating platform 19. The bearing means 25 are two fingers, which are moveable in the longitudinal direction and can be advanced into and pulled out of the structure clearance of stacking well 12 with the aid of a working cylinder 27. The two fingers 25 penetrate through corresponding holes in limit stop 14, which is located upstream, and position themselves underneath the bottom conveyor roller 16. The two fingers 25 are located such a distance from each other, that they can laterally support the smallest folding-box tubes to be processed. For the case in which two fingers of this type are inadequate when very wide blanks are to be stacked, additional fingers 25 can still be attached toward the outside in addition to these two fingers. All fingers 26 are driven synchronously and advanced into or pulled out of the stacking well 12 simultaneously.

Fingers 26 are likewise located underneath the downstream limit stop 13 and can likewise be advanced into or pulled out of the structure clearance of stacking well 12.

The driving mechanisms for the fingers 26 are not shown for the sake of clarity.

Fingers 25 and 26 each define a plane that runs perpendicular to limit stop 14 and limit stop 13 and that is not inclined crosswise to the conveying direction.

A second temporary bearing means, which is likewise designed as a rack comprising of prongs 28 regularly spaced from each other, is operative within the stacking well.

The prongs 28 are seated in a transverse bar and, depending on the operating position, project into the structure clearance of stacking well 12 through the slots in the downstream limit stop 13.

Two guide bars 31 parallel to each other are located on the back of the downstream limit stop 13. Only one of these can be seen for reasons of illustration.

The two guide bars 31 are seated below on a subframe 32 and serve as guide bars for a guide block 33, upon which the girder 29 is guided underneath the bars. Slide block 33 can be moved along the two guide bars 31 by means of an unillustrated toothed belt with the aid of a driving mechanism that isn't shown. Subframe 32 is swivel-mounted in machine frame 4 by means of an axle 35, which is fastened to portions of the frame that aren't shown. The axle 35 runs underneath the guide bars 31.

The axle 35 runs horizontally and perpendicular to the conveying direction of the products 3. A connecting rod arrangement 37 guides the opposite end of subframe 32 in frame-fast vertical guide bars 38. Here too, the driving mechanism for the connecting rods 37 and an associated slide block 41 running in the guide bars 38 is not shown for reasons of clarity.

Jack screw drives, for example, come into consideration for the vertical motion of the slide block 41, whereas a continuous toothed belt effects the longitudinal motion of slide block 33.

The prongs 28 of the second temporary bearing means can be pulled back behind the downstream limit stop 13 in this manner, and they can also execute swiveling movement in relation to the axle 35.

At the height of the bottom position of elevating platform 19, a conveying device 42, comprising of a plurality of continuous conveying belts in the form of flat belts 43 running parallel to each other, starts at columns 5. Conveyor rollers 44, which are mounted rotatable in the machine frame, support the belts 23 along the conveying distance. In this manner, the conveying belts 43 form driving strands, which extend along a plane that runs perpendicular to the planes defined by the two limit stops 13 and 14. The plane defined by the driving strands of conveying belts 43 ascends, proceeding from column 5. The clearance between conveying belts 43 and the arrangement of bearings is selected in such a manner that the belts partially engage between the prongs of elevating platform 19 or run past it laterally, thereby preventing a collision.

A holding down appliance 45, formed by three continuous belts 46 running parallel to each other, is located above the conveying device 42. The clearance that the continuous belts have from each other is selected so that the prongs 28 fit between the belts, whereby a conveying belt 46 runs in the middle of the group of prongs 28. The pulley block needed for this is mounted next to the back of limit stop 13 behind one of its corresponding prongs.

The holding down appliance 45 starts right behind the limit stop 13 located downstream and, as shown, extends approximately to the end of conveying device 42. The lower edge of limit stop 13 aligns with the plane defined by the driving strands of conveying belts 46. A channel, that demonstrates the same slight height at its beginning and end, is defined between the holding down appliance 45 and the conveying device 42.

Figure schematically indicates the mounting rollers for the conveying belts 43 and 46, but they will not be discussed further below because the type and manner of the arrangement of bearings is well-known to a person skilled in the art and the type and manner of arrangement of bearings is moreover not important for further understanding of the invention.

The functional operation of the stacking device will now be explained based on FIGS. 2 through 10.

The clearance between the two limit stops 13 and 14 is set by adjusting the position of limit stop 13. The clearance is selected such that the products 3 basically fit in between free from play, when they rest upon one of the bearing means or upon elevating platform 19, respectively.

In the starting position depicted in FIG. 2, the elevating platform 19 is raised to its top position. The prongs 28 are advanced into the structure clearance of stacking well 12, because the guide bars 31 are swung into their lowest position. In this position, the undersides of prongs 28 run into an extension of the surface that is defined by the driving strands of conveying belts 46 of the holding down appliance 45. In this position, the prongs 28 align with the corresponding gaps in the platform 19 to prevent collisions to a large extent.

The fingers 25 and 26 of the first bearing means advance into the structure clearance, and in such a way that they collide neither with the prongs 28 nor with the elevating platform 19.

When the first folding-box tube 3 shoots in, in this position depicted in FIG. 2, it comes to rest on the upper surface of prongs 28. Additional folding-box tubes settle down as shown in FIG. 3 on the stack that already exists and is located within the stacking well 12 underneath the additional tube in question. The upper surface of prongs 28 still bear the stack at first.

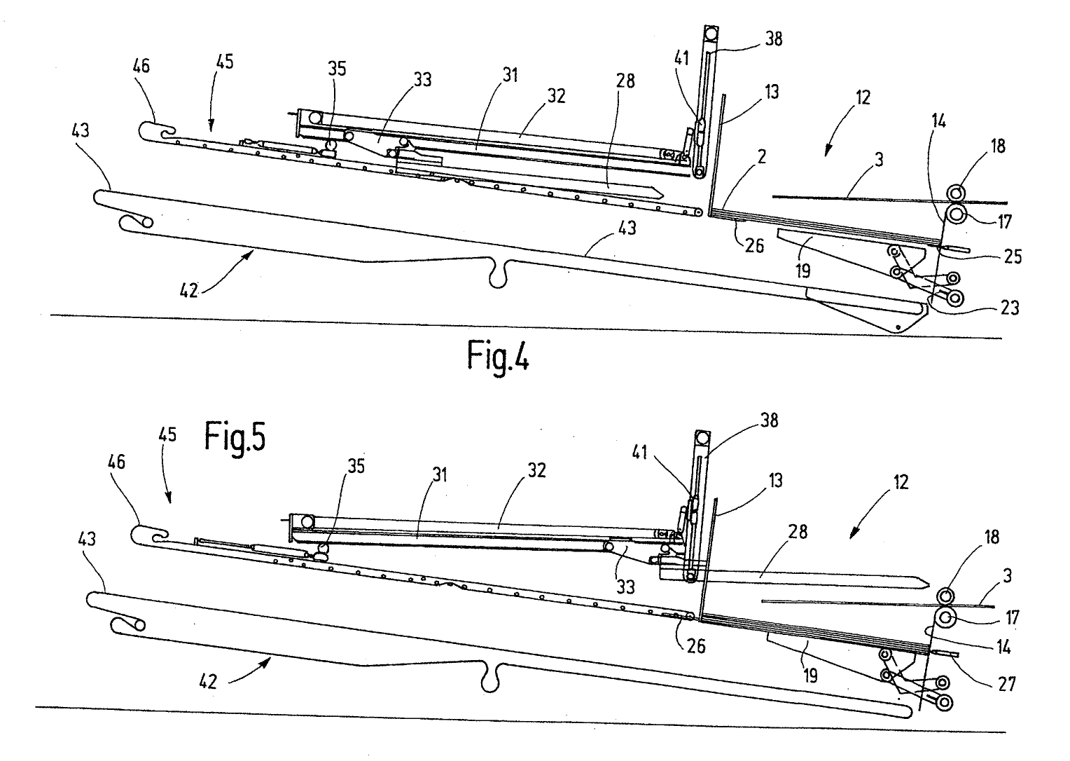

After several folding-box tubes 3 have arrived, sliding block 33 is pulled back along the guide bars 31, as shown in FIG. 4, far enough until the open ends of prongs 28 have been fully extracted from the stacking well 12 and have disappeared behind limit stop 13. The already existing low stack of 3 or 4 folding-box tubes lying one on top of the other falls onto the fingers 26 and 27 while the prongs 28 pull out of stacking well 12. These fingers likewise pull back so that the stack now comes to rest upon the upper surface of elevating platform 19, as shown in FIG. 5.

In FIG. 4, the lifting of prongs 28 has already begun. They have been placed a little upwards, in other words they no longer run precisely parallel to the plane that corresponds to the driving strands of continuous belts 46.

As the stacking of the folding-box tubes takes place on elevating platform 19, the guide bars 31 swing upwards around axle 35 into their top stop position. For this, the slide block 41, which is guided and appropriately driven in the guide bars 38, raises the guide bars 31 on their ends that are adjacent to limit stop 13.

After the top position has been reached, the rotary actuator for guide bars 31 shuts off and the drive for slide block 33 goes into action instead. The prongs 28 advance through the gaps in limit stop 13 into the stacking well 12. In their advanced position, their undersides are clearly above the plane along which the folding-box tubes 3 shoot into the stacking well 12, as can be seen in FIG. 5.

As soon as the desired number of folding-box tubes in stack 2 has been attained, the rotary actuator for guide bars 31 goes into action in the lowering direction. In so doing, the prongs 28 run downwards through stacking well 12 in parallel flow with the falling folding-box tubes 3.

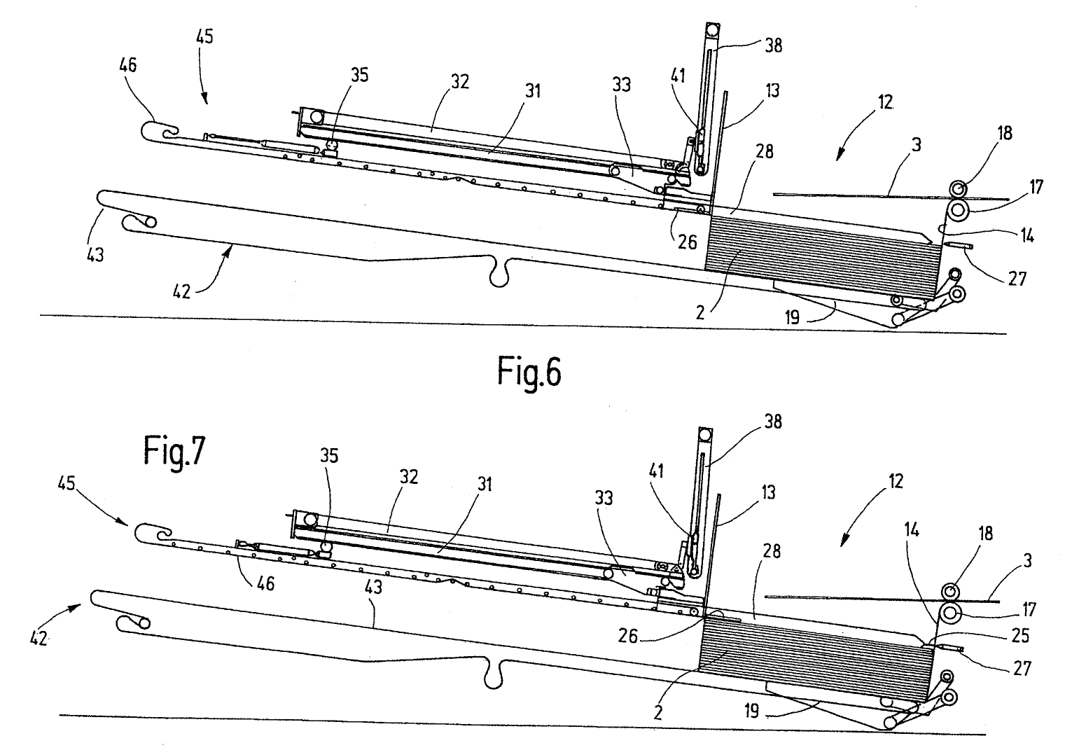

During the transition from FIG. 5 to FIG. 6, the elevating platform 19 lowers continuously to the extent in which the stack 2 has become higher, so that the upper edge or the head of the stack always remains approximately the same distance from the shoot-in plane so that approximately equal drop ratios are present for the folding-box tubes that end up in the stacking well 12. During the stacking, the eccentric shaft 15 simultaneously moves limit stop 14 against the stack periodically in order to vibrate the stack together and still correct warpage errors a little in case the seams have become glued to the folding-box blanks.

The top layers of blanks hold the lower layers tight. Only the top layers can spring up somewhat due to the elastic pull of the corrugated cardboard.

The lowering of prongs 28 into the stacking well 12 is synchronized so that the tips of prongs 28 pass through the shoot-in plane on the conveyor rollers just at the instant at which no folding-box tube 3 shoots in.

After the prongs 28 have been lowered to the head of the stack and press the stack together, the fingers 26 and 27 advance, as can be seen in FIG. 7. The stack is pressed together in FIG. 7 by the prongs 28, which press from above with force. This creates space to advance the fingers 26 and 27 into stacking well 12.

As soon as the prongs 28 rest on the stack 2, further stacking occurs of necessity on the upper surface of prongs 28, which press together the stack 2 located beneath them. The conveying device for slide block 33 now goes into action to move the prongs 28 in the direction of flow. Simultaneously, the conveying belts 43 of conveying device 42 and conveying belts 46 of the holding-down appliance 45 turn on. The stack 2, which is pressed together with the aid of prongs 28, is thus threaded into the channel between the holding-down appliance 45 and the conveying device 42 and moved in the conveying direction, as shown in FIG. 9. In so doing, all parts engaging stack 2 run at the same linear speed.

After the stack 2 has been completely threaded in as depicted in FIG. 10, which will occur no later than the time that slide block 33 has reached its most distant position from limit stop 13, the cycle starts again with FIG. 4.

The stacking onto the fingers 26 and 27 occurs while the completed stack 2 is carried away, so that time is created to move the elevating platform 19, which is now free, back up to its starting position. The cooperation between the stacking onto the fingers 25 and 26 and stacking onto elevating platform 19 provides enough time to bring the prongs 28 back along their relatively long path and into their starting position as depicted in FIG. 5.

The fingers 25 and 26 can be dimensioned relatively thin, because the stack that they have to carry until the elevating platform is back into position is relatively small and therefore light.

The basic advantage of the fitting arrangement according to invention consists of the fact that the prongs execute a swiveling movement relative to axle 35. This substantially simplifies the arrangement of bearings. In addition, the rotary actuator and the horizontal drive are mechanically disengaged from each other. In this manner, the longitudinal travel that the prongs 28 execute parallel to the surface of elevating platform 19 is limited just to the extent necessary to pull them back behind limit stop 13. They do not have to traverse the same travel for small folding-box tubes 3 as in the case of large blanks. The folding machine, which generates the folding-box tubes 3, can thus run substantially faster for small blanks than for large blanks, resulting in higher output even though the cycle time is predefined by the structure of the folding belts.

To the extent that no dimensional information has been made for lengths and widths, they result from the above functional description in a manner that is self-understood.

For folding-box tubes that posses very large dimensions as viewed in the conveying direction, the leading edge of the of the folding-box tube shooting into the stacking well 12 can prematurely come into contact with the upper surface of the stack that has already been built. Its front edge then tends to interlock, depending on the circumstances, and the cardboard will remain lying crooked within the well 12.

To prevent this effect, the top yoke 9 or underframe 11 can be lowered somewhat, as depicted in FIG. 11, providing a greater depth to the stacking well. Another set of fingers 25′, lying underneath fingers 25 and located around the height of the extra depth, are consequently provided at columns 5.

During the lowering, the downstream limit stop 13 and the holding-down appliance 45 are appropriately lowered along. Since the fingers 26 are fastened to the downstream rack 13, extra components are saved here.

A device for stacking folding-box tubes demonstrates a vertically-adjustable elevating platform. First temporary bearing means, which can be pulled out of or advanced into the stacking well, are located above the elevating platform. Another set of temporary bearing means can be pulled out of the stacking well as well as moved downward within the stacking well. The second bearing means also press a completed stack together in order to be able to thread it between a conveying device of a holding-down appliance. The first temporary bearing means provide for uninterrupted stacking within the stacking well while the elevating platform, together with the second bearing device, are busy carrying the stack away.

I claim:

1. Device for stacking flat products, in particular folding box blanks (3) or folding box tubes that are processed in a stream,
with a machine frame (4),
with a conveying device (16), located upstream on the machine frame,
with a stacking well (12), located downstream of the conveying device (16) on the machine frame (4) which is restricted upstream and downstream by limit stops (13, 14),
with an elevating platform (19), which moves up and down through the clearance of the stacking well (12) in the machine frame (4),
with first temporary bearing means (25, 26), which are moveable in the longitudinal direction and can be advanced into and pulled out of the structure clearance of the stacking well (12) of the machine frame
with a conveying device (42), that begins in the structure clearance of the stacking well (12) and extends downstream into the machine frame (4),
with a holding down appliance (45), that begins outside the structure clearance of the stacking well and extends itself along and above the conveying device, and with second temporary bearing means (28), that can be advanced into and pulled out of the structure clearance of the stacking well (12) and as well pivot around an axle (35) outside of the stacking well (12), and thereby lowers in parallel flow with the moving product (3) coming from the conveying device (16) into the stacking well (12) downward to the height of the holding down appliance (45).

2. Device according to claim 1, characterized in that, the conveying device (16) has a circumferential speed larger than the speed corresponding to the conveying velocity that delivers the products 3.

3. Device according to claim 1, characterized in that, the conveying device (16) comprises two conveyor rollers (17, 18) that are mounted, horizontally and with parallel axes both of which work when only one is in motion.

4. Device according to claim 1, characterized in that, the stacking well (12) is open on the side.

5. Device according to claim 1, characterized in that, the limit stop (14) located upstream is positioned below the conveying device (16) and continues until it reaches a height, that is lower than the top side of the elevating platform (19) when said platform is in its lowest position.

6. Device according to claim 1, characterized in that, the limit stop (14) located upstream is a vibrator.

7. Device according to claim 1, characterized in that, the limit stop (14) located upstream comprises of a basically flat plate, which demonstrates vertical slots and rises vertically through the stacking well (12) beneath the dropped product (3)

8. Device according to claim 1, characterized in that, the limit stop (13) located downstream has a lower edge that is lower than the top side of the elevating platform (19) when said platform is in its highest position.

9. Device according to claim 1, characterized in that, the limit stop (13) located downstream has the shape of a rack ( ), and comprises of a plurality of prongs that basically hang vertically downwards that define a relatively parallel surface.

10. Device according to claim 1, characterized in that, the elevating platform (19) has the shape of a rack, and comprises of a plurality of prongs regularly spaced from each other, whose free ends point downstream.

11. Device according to claim 1, characterized in that, the elevating platform (19) is mounted in the machine frame (4) below and upstream from the limit stop (14) located upstream.

12. Device according to claim 1, characterized in that, the limit stop (14) located upstream demonstrates vertical slots to allow passage of the bearings (22, 23) of the elevating platform (19).

13. Device according to claim 1, characterized in that, the first temporary bearing means (25, 26) have in total four fingers, two are moveable in the longitudinal direction and can be advanced into and pulled out of the stacking well (12), two that can be advanced into and pulled out of the structure clearance of the stacking well (12) each defining a plane that runs perpendicular to limit stop 14 and limit stop 13 and that is not inclined crosswise to the conveying direction.

14. Device according to claim 1, characterized in that, the output transport device (42) has a plurality of continuous conveying belts (43) running parallel to each other.

15. Device according to claim 14, characterized in that, the elevating platform (19) has the shape of a rack and at least two prongs, and that at least one of the conveying belts (43) extends between said prongs.

16. Device according to claim 14, characterized in that, in relation to the width of the transport path, the conveying belts (43) located outside run around pulley blocks, that are mounted in the machine frame (4) to the side of and next to the elevating platform (19) in the area of the limit stop (14) located upstream.

17. Device according to claim 14, characterized in that, all conveying belts (43) are driven at the same velocity.

18. Device according to claim 14, characterized in that, the conveying belts (43) with their driving strands define a plane transport surface which rises in the transport direction.

19. Device according to claim 14, characterized in that, the conveying belts are supported by rollers (44) in the area of their driving strands.

20. Device according to claim 1, characterized in that, the holding down appliance (45) has a plurality of continuous conveying belts (46) running parallel to each other.

21. Device according to claim 20, characterized in that, the conveying belts (46) run the holding down device (42) around pulley blocks, that pivot downstream next to the limit stop (13) located downstream in the machine frame (4).

22. Device according to claims 14 and 20, characterized in that, the driving strands of the conveying belts (46) of the holding down appliance (42) define a plane that is parallel to the plane of the conveying belts (43) of the transport device (42).

23. Device according to claims 14 and 20, characterized in that, the conveying belts (43) of the transport device (42) and the conveying belts (46) of the holding down appliance (45) operate at the same velocity.

24. Device according to claim 1, characterized in that, the second temporary bearing means (28) is formed as a rack, that has prongs parallel in distance to one another, that move through the gaps between the prongs of the limit stop (13) located downstream.

25. Device according to claim 1, characterized in that, the second temporary bearing means (28) is mounted on a guide block (33) that is driven downstream from the limit stop (13) located downstream.

26. Device according to claim 25, characterized in that, in order to move the guide block (33) a guide rail is provided (31) which swivels around an axle (35), that extends itself horizontal and at a right angle to the transport direction of the product (3) on the transport device (42).

27. Device according to claim 1, characterized in that, attached on the guide rail (31) are driving means (37, 38, 41), that move the guide rail (31) up and down around the axle (35).

28. Device according to claim 1, characterized in that, driving means are provided to move the guide block (33) along the guide rail (31).

29. Device according to claim 1, characterized in that, controlling means are available to coordinate the movements of the moveable parts of the device (1).

30. Device according to claim 1, characterized in that, the driving means (37, 38, 41) for the guide rail (31) contain vertical guide-bars (38) in which a further adjusting slide block (41) can be vertically moved, and to which the guide rail (31) is linked.

31. Device according to claim 1, characterized in that, to set the clearance of the stacking well (12) the limit stop (13) located downstream is adjustable in the machine frame (4), so that, its distance to the limit stop located downstream is adjustable to the size of the product (3) moving in the transport direction.

32. Device according to claim 1, characterized in that, the lift of the second temporary bearing means (28) is adjustable parallel in direction to the guide rail (31), so that, the empty lift around the prongs of the second temporary support means (28) out of the clearance of the stacking well (12) is minimized.

33. Device according to claim 1, characterized in that, the driving means (37, 38, 41) to swivel the guide rail (31) around the axle (35) and the drive that moves the carriage of the second temporary bearing means (28) are mechanically disengaged from one another, so that, the horizontal movement and the lift are independent.

34. Device according to claim 1, characterized in that, the holding down appliance (45) is changeable in a perpendicular direction to the transport plane defined by the transport device (42).

35. Device according to claim 1, characterized in that, a third temporary bearing means (25′) is provided, which has at least 2 fingers, that are located just at the height of the lowered holding down appliance (45) near the limit stop (14) located upstream.

36. Device according to claim 1, characterized in that, the second temporary bearing means (28) can be positioned in a lower position, where its bottom is located at the height of the plane, that is defined by the driving strands of the holding down appliance (45)

37. Device according to claim 36, characterized in that, while in its lower position the guide rail (31) for the second bearing means (28) runs parallel to the plane defined by the driving strands of the holding down device (45).

38. Device according to claim 1, characterized in that, to guide the stack (2) out of the stacking well (12) the second temporary bearing means (28) is removed with the same linear velocity from the stacking well (12) as moves the driving strands of the transport device (42) and the driving strands of the holding down appliance (45).

39. Device according to claim 1, characterized in that, a continuous belt (46) of the holding down appliance (45) is located on the back side area of the limit stop (13) located downstream and runs between the prongs of the pulled back second temporary bearing means (28).
